(19) United States
(12) Patent Application Publication
(10) Pub. No.: US 2021/0179830 A1
(43) Pub. Date: Jun. 17, 2021

(54) Polymer Composition Comprising Polypropylene

(71) Applicant: TOTAL RESEARCH & TECHNOLOGY FELUY, Seneffe (BE)

(72) Inventors: Alain Standaert, Bruxelles (BE); Isabelle Ydens, Saint Vaast (BE); Gabriela Quevedo Silvetti, Nivelles (BE); Daniel Libert, Court-Saint-Etienne (BE)

(21) Appl. No.: 16/760,353

(22) PCT Filed: Oct. 27, 2018
(86) PCT No.: PCT/EP2018/079519

§ 371 Date: Apr. 29, 2020

(30) Foreign Application Priority Data
Oct. 31, 2017 (EP) 17199430.4

(51) Int. Cl. C08L 23/14; C08L 23/06; C08L 23/08

(52) U.S. Cl. CPC C08L 23/14; C08L 23/06; C08L 2207/02; C08L 2205/03; C08L 2203/30; C08L 23/0853

(57) ABSTRACT

The present invention relates to a polymer composition comprising:
a polypropylene;
a first polyethylene (A) having a melt flow rate MI2 inferior to 0.2 g/10 min as determined according to ISO 1133, condition D, at 190° C. and under a load of 2.16 kg;
at least one ethylene vinyl acetate copolymer; and
optionally a second polyethylene (B) having a melt flow rate MI2 of at least 0.2 g/10 min as determined according to ISO 1133, condition D, at 190° C. and under a load of 2.16 kg;
   wherein the flow rate ratio of the melt flow rate of the polypropylene, determined according to ISO 1133, condition M at 230° C. and under a load of 2.16 kg, to the melt flow rate MI2 of the first polyethylene (A) is at least 200.

The present invention also relates to an article comprising a polymer composition according to the invention and further relates to a process for making said article.

### FIELD OF THE INVENTION

The present invention relates to a polymer composition comprising polypropylene, to the use of said polymer composition for the preparation of an article and to said article comprising said polymer composition.

### BACKGROUND OF THE INVENTION

Polypropylene products are used in many applications where mechanical properties are of high importance (crates, bins, boxes, trays, automotive parts, food packaging produced by injection molding, extrusion blow molding, extrusion thermoforming, etc.); relevant mechanical properties include stiffness and impact resistance. Processing and aesthetical properties are also of high importance for most converters and end-users.

The traditional method of modifying the impact resistance of polypropylene is by addition of a dispersed polymeric phase offering impact resistance; this can be achieved by extrusion blending or by copolymerization. Impact modifier polymers include elastomers, plastomers, EPR, EPDM, PBu, SEBS, LDPE, LLDPE, HDPE, . . . . The limitation of this technique is often linked to the rapid loss of stiffness and the lack of compatibility between the dispersed phase and the polypropylene matrix. Amorphous elastomers increase the impact resistance with a high efficiency but have a detrimental effect on the stiffness while semi-crystalline polymers such as polyethylene have a less detrimental effect on the stiffness but a limited effect on the impact resistance; moreover the compatibility between polypropylene and polyethylene is often an issue if the quantity or the viscosity of the polyethylene phase is too high.

Current post-consumer recycled polyolefins (i.e. rPE or rPP) contain a blend of PP's with PE's from different origins and in various amounts depending on the sorting technology. These blends, most of the time, exhibit poor mechanical and aesthetic performances linked to the poor compatibility of one polymer into the main one. Consequently, virgin material has to be added to boost the mechanical properties and the recycled material is often dedicated to low end applications.

There is therefore a demand for polymer compositions comprising polypropylene having improved mechanical properties such as stiffness, impact resistance and good processability.

It is therefore an object of the present invention to provide polymer composition comprising polypropylene having improved mechanical properties.

### SUMMARY OF THE INVENTION

It has now surprisingly been found that the above objective can be attained either individually or in any combination by a polymer composition comprising the specific and well-defined polymers as disclosed herein.

Thus, in a first aspect, the present invention provides for a polymer composition comprising:
a polypropylene;
a first polyethylene (A) having a melt flow rate MI2 inferior to 0.2 g/10 min as determined according to ISO 1133, condition D, at 190° C. and under a load of 2.16 kg;
at least one ethylene vinyl acetate copolymer; and
optionally a second polyethylene (B) having a melt flow rate MI2 of at least 0.2 g/10 min as determined according to ISO 1133, condition D, at 190° C. and under a load of 2.16 kg;
   wherein the flow rate ratio of the melt flow rate of the polypropylene (MI_{PP}) determined according to ISO 1133, condition M at 230° C. and under a load of 2.16 kg to the melt flow rate MI2 of the first polyethylene (A):

$$\frac{{MI}_{PP ( ISO 1133 , 230 ° C . , 2.16 kg )}}{{MI}_{P E ( A ) ( ISO 1 \; 133 , 190 ° C . , 2.16 kg )}}$$

is at least 200.

In addition, in a second aspect, the present invention encompasses an article comprising the polymer composition according to the first aspect of the invention.

In addition, in a third aspect, the present invention encompasses a process for making an article according to the second aspect comprising the steps of preparing a polymer composition according to the first aspect of the invention and processing said polymer composition into an article.

The inventors have shown that the present composition exhibited improved compatibility between the polypropylene matrix and the dispersed phase, whatever its composition, when compared to prior art compositions comprising only polypropylene mixed with high viscosity polyethylene. These prior art polymer compositions had poor dispersion. A poor dispersion is characterized by poor mechanical properties such as low Falling Weight impact or poor optical properties on film measured by the number and the size of gels, the haze and other surface defects like breakage. The present compositions exhibited improved mechanical and optical properties.

The independent and dependent claims set out particular and preferred features of the invention. Features from the dependent claims may be combined with features of the independent or other dependent claims as appropriate.

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

### BRIEF DESCRIPTION OF THE FIGURES

FIG. 1 represents a graph plotting Tan Delta as a function of ω_{/}ω_{c} as measured at a temperature of 230° C., for comparative compositions 3 and 4, compositions 1 and 2 according to invention and PPC 10642.

FIG. 2 represents a Radar Plot showing properties of composition 2 according to the invention compared on a relative basis to comparative composition 4, and PPC 10642.

### DETAILED DESCRIPTION OF THE INVENTION

When describing the invention, the terms used are to be construed in accordance with the following definitions, unless a context dictates otherwise.

As used herein, the singular forms “a”, “an”, and “the” include both singular and plural referents unless the context clearly dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

Preferred statements (features) and embodiments of the polymer compositions, articles uses and process of this invention are set herein below. Each statements and embodiments of the invention so defined may be combined with any other statement and/or embodiments unless clearly indicated to the contrary. In particular, any feature indicated as being preferred or advantageous may be combined with any other feature or features or statements indicated as being preferred or advantageous. Hereto, the present invention is in particular captured by any one or any combination of one or more of the below numbered aspects and embodiments 1 to 25, with any other statement and/or embodiments.
1. A polymer composition comprising:
   a polypropylene;
   a first polyethylene (A) having a melt flow rate MI2 inferior to 0.2 g/10 min as determined according to ISO 1133, condition D, at 190° C. and under a load of 2.16 kg;
   at least one ethylene vinyl acetate copolymer; and
   optionally a second polyethylene (B) having a melt flow rate MI2 of at least 0.2 g/10 min as determined according to ISO 1133, condition D, at 190° C. and under a load of 2.16 kg;
      wherein the flow rate ratio of the melt flow rate of the polypropylene determined according to ISO 1133, condition M at 230° C. and under a load of 2.16 kg to the melt flow rate MI2 of the first polyethylene (A) is at least 200, preferably at least 300, preferably at least 400, preferably at least 500 (i.e. ratio

$$\frac{{MI}_{PP ( ISO 1133 , 230 ° C . , 2.16 kg )}}{{MI}_{P E ( A ) ( ISO 1 \; 133 , 190 ° C . , 2.16 kg )}} \geq 200 ,$$

preferably ≥300, preferably ≥400, preferably ≥500).
2. The polymer composition according to statement 1, wherein said polypropylene is a propylene copolymer, preferably said polypropylene is a copolymer of propylene with one or more comonomers selected from ethylene and a C4 to C12 olefin, preferably said polypropylene is a copolymer of propylene with ethylene as comonomer.
3. The polymer composition according to any one of statements 1 or 2, wherein said at least one polypropylene is a heterophasic propylene copolymer, preferably said polypropylene is a heterophasic copolymer of propylene with one or more comonomers selected from ethylene and a C4 to C12 olefin, preferably wherein said polypropylene is a heterophasic copolymer of propylene with ethylene as comonomer.
4. The polymer composition according to any one of statements 1 to 3, wherein said first polyethylene (A) has a high load melt index (HLMI) of at most 20.0 g/10 min, preferably at most 15.0 g/10 min, preferably at most 10.0 g/10 min, preferably at most 5.0 g/10 min, preferably of from 0.1 g/10 min to 20.0 g/10 min, preferably from 0.5 g/10 min to 10.0 g/10 min, more preferably from 0.7 g/10 min to 5.0 g/10 min, most preferably from 1.0 g/10 min to 2.5 g/10 min, wherein the HLMI is determined according to ISO 1133, condition G, at 190° C. and under a load of 21.6 kg.
5. The polymer composition according to any one of statements 1 to 4, wherein said polymer composition comprises at most 20.0% by weight of said first polyethylene (A), preferably at most 17.0% by weight, preferably at most 15.0% by weight, preferably at most 13.0% by weight, preferably at most 10.0% by weight, for example at most 8.0% by weight, for example at most 7.0% by weight, for example at most 6.0% by weight, for example at most 5% by weight, preferably said composition comprises at least 1.0% by weight of said first polyethylene (A) based on the total weight of the polymer composition.
6. The polymer composition according to any one of statements 1 to 5, wherein said polymer composition comprises from 55.0% to 97.5% by weight of polypropylene, preferably from 60.0% to 97.5% by weight, preferably from 70.0% to 97.0% by weight, for example from 80.0% to 97.0% by weight, for example from 85.0% to 97.0% by weight, for example from 87.0% to 97.0% by weight of polypropylene based on the total weight of the polymer composition.
7. The polymer composition according to any one of statements 1 to 6, wherein said polymer composition comprises from 0.5% to 5.0% by weight of said at least one ethylene vinyl acetate copolymer, preferably from 1.0% to 5.0% by weight, preferably from 1.0% to 4.0% by weight, preferably from 1.0% to 3.5% by weight based on the total weight of the polymer composition.
8. The polymer composition according to any one of statements 1 to 7, wherein said polymer composition comprises
   from 55.0% to 97.5% by weight of polypropylene, preferably from 60.0% to 97.5% by weight, preferably from 70.0% to 97.5% by weight, for example from 80.0% to 97.5% by weight, for example from 85.0% to 97.0% by weight based on the total weight of the polymer composition;
   at most 20.0% by weight of said first polyethylene (A), preferably at most 17.0% by weight, preferably at most 15.0% by weight, preferably at most 13.0% by weight, preferably at most 10.0% by weight, for example at most 8.0% by weight, for example at most 7.0% by weight, for example at most 6.0% by weight, for example at most 5% by weight based on the total weight of the polymer composition;
   from 0.5% to 5.0% by weight of said at least one ethylene vinyl acetate copolymer, preferably from 1.0% to 5.0% by weight, preferably from 1.0% to 4.0% by weight, preferably from 1.0% to 3.5% by weight based on the total weight of the polymer composition; and
   from 0 to 20.0% by weight of said second polyethylene (B), preferably from 0% to 15.0% by weight, preferably from 0% to 13.0% by weight, preferably from 0% to 10.0% by weight, of the second polyethylene (B) having a melt flow rate MI2 of at least 0.2 g/10 min, preferably of at least 0.5 g/10 min, preferably of at least 1.0 g/10 min.
9. The polymer composition according to any one of statements 1 to 8, wherein said polymer composition comprises from 55.0% to 97.5% by weight of propylene copolymer, preferably from 60.0% to 97.5% by weight, preferably from 70.0% to 97.5% by weight, for example from 80.0% to 97.5% by weight, for example from 85.0% to 97.5% by weight based on the total weight of the polymer composition; preferably the propylene copolymer is heterophasic propylene copolymer;
   from 1.0% to 20.0% by weight of said first polyethylene (A) based on the total weight of the polymer composition, preferably from 1.0% to 17.0% by weight of said first polyethylene (A), preferably from 1.0% to 15.0% by weight, preferably from 1.0% to 13.0% by weight, preferably from 1.0% to 10.0% by weight, for example from 1.0% to 8.0% by weight, for example from 1.0% to 7.0% by weight, for example from 1.0% to 6.0% by weight based on the total weight of the polymer composition, for example from 1.0% to 5% by weight;
   from 0.1% to 5.0% by weight of said at least one ethylene vinyl acetate copolymer, preferably from 0.5% to 5.0% by weight, preferably from 1.0% to 5.0% by weight, preferably from 1.0% to 4.0% by weight, preferably from 1.0% to 3.5% by weight based on the total weight of the polymer composition; and
   from 1.0% to 20.0% by weight of the second polyethylene (B), preferably from 1.0% to 15.0% by weight, preferably from 1.0% to 13.0% by weight, preferably from 1.0% to 10.0% by weight, of the second polyethylene (B) having a melt flow rate MI2 of at least 0.2 g/10 min, preferably of at least 0.5 g/10 min, preferably of at least 1.0 g/10 min.
10. The polymer composition according to any one of statements 1 to 9, wherein said polymer composition comprises a total amount of at most 40.0% by weight of first polyethylene (A) and optional polyethylene (B), preferably at most 30.0% by weight, preferably at most 20.0% by weight, preferably at most 15.0% by weight based on the total weight of the polymer composition.
11. The polymer composition according to any of one statements 1 to 10, wherein said polymer composition comprises said second polyethylene (B) having a melt flow rate MI2 of at least 0.2 g/10 min, preferably of at least 0.5 g/10 min, preferably of at least 1.0 g/10 min.
12. The polymer composition according to any of one statements 1 to 11, wherein said second polyethylene (B) has a melt flow rate MI2 of at most 20.0 g/10 min, preferably of at most 15.0 g/10 min, preferably of at most 10 g/10 min.
13. The polymer composition according to any of one statements 1 to 12, wherein said second polyethylene (B) has a melt flow rate MI2 of at least 0.2 g/10 min to at most 20.0 g/10 min, preferably of at least 0.2 g/10 min to at most 15.0 g/10 min, preferably of at least 0.2 g/10 min to at most 10.0 g/10 min, for example of at least 0.5 g/10 min to at most 20.0 g/10 min, for example of at least 0.5 g/10 min to at most 15.0 g/10 min; for example of at least 0.5 g/10 min to at most 10.0 g/10 min; for example of at least 1.0 g/10 min to at most 10.0 g/10 min.
14. The polymer composition according to any one of statements 1 to 13, wherein said polymer composition comprises a total amount of at least 2.0% by weight of said at first polyethylene (A) and second polyethylene (B) based on the total weight of the polymer composition.
15. The polymer composition according to any one of statements 1 to 14, wherein said second polyethylene (B) is present in an amount of at least 25.0% by weight, the amount being based on the total amount of said first polyethylene (A) and second polyethylene (B).
16. The polymer composition according to any one of statements 1 to 15, wherein said first polyethylene (A) and said second polyethylene (B) are present in equal amounts in said polymer composition.
17. The polymer composition according to any one of statements 1 to 16, wherein said polypropylene comprises one or more nucleating agents.
18. The polymer composition according to any one of statements 1 to 17, wherein said ethylene vinyl acetate copolymer has a vinyl acetate content of at least 4.0% by weight based on the total weight of the ethylene vinyl acetate copolymer, as determined by ¹H-NMR analysis.
19. The polymer composition according to any one of statements 1 to 18, wherein said ethylene vinyl acetate copolymer has a melt flow rate MI superior to 0.1 g/10 min as determined according to ISO 1133, condition D, at 190° C. and under a load of 2.16 kg, preferably at least 0.4 g/10 min, preferably at least 0.5 g/10 min, for example at least 0.5 g/10 min to at most 9 g/10 min, for example at least 0.5 g/10 min to at most 8 g/10 min, for example at least 0.5 g/10 min to at most 7 g/10 min, for example at least 0.5 g/10 min to at most 6 g/10 min, for example at least 0.5 g/10 min to at most 5 g/10 min, for example at least 0.5 g/10 min to at most 4.5 g/10 min.
20. An article comprising a polymer composition according to any one of statements 1 to 19.
21. The article according to statements 20, wherein said article is an extruded article.
22. The article according to statements 20 or 21, wherein said article is an injected article.
23. A process for preparing an article according to any one of statements 20 to 22 comprising the steps of preparing a polymer composition according to any one of statements 1 to 19 and processing said polymer composition into an article.
24. The process according to statement 23 comprising the steps of
   a) blending, preferably melt blending:
      a polypropylene;
      a first polyethylene (A) having a melt flow rate MI2 inferior to 0.2 g/10 min as determined according to ISO 1133, condition D, at 190° C. and under a load of 2.16 kg;
      at least one ethylene vinyl acetate copolymer; and
      optionally a second polyethylene (B) having a melt flow rate MI2 of at least 0.2 g/10 min;
      wherein the flow rate ratio of the melt flow rate of the polypropylene determined according to ISO 1133, condition M at 230° C. and under a load of 2.16 kg to the melt flow rate MI2 of the first polyethylene (A)

$$\frac{{MI}_{PP ( ISO 1133 , 230 ° C . , 2.16 kg )}}{{MI}_{P E ( A ) ( ISO 1 \; 133 , 190 ° C . , 2.16 kg )}}$$

is at least 200;
(b) extruding the blend,
(c) processing the extruded blend in to an article.
25. The process according to any one of statements 23 or 24, wherein said processing step comprises using one or more polymer processing techniques selected from injection molding; pipe and fiber extrusion or coextrusion; film and sheet extrusion or co-extrusion, blow molding; rotational molding; foaming; and thermoforming.

According to the present invention, the present polymer composition comprises at least one polypropylene. For the purposes of the present application, the term “polypropylene” is used to denote propylene homopolymer as well as propylene copolymers. If the propylene is a copolymer, the comonomer can be any alpha-olefin i.e. any C2 to C12 alpha-alkylene. The polypropylene can be atactic, isotactic or syndiotactic polypropylene. The copolymer can be either a random or heterophasic copolymer.

Preferably the polypropylene for use in the present polymer composition is a propylene copolymer, more preferably a copolymer of propylene with one or more comonomers selected from ethylene and a C4 to C12 olefin. Preferably said propylene copolymer is present in the polymer composition in an amount ranging from 55.0% to 97.5% by weight based on the total weight of the polymer composition, preferably from 65.0% to 97.5% by weight, preferably from 75.0% to 97.0% by weight, for example from 85.0% to 97.0% by weight, for example from 87.0% to 97.0% by weight.

More preferably, the polypropylene is a heterophasic propylene copolymer, preferably a heterophasic copolymer of propylene with one or more comonomers selected from ethylene and a C4 to C12 olefin. Preferred comonomers are ethylene, 1-butene, 1-pentene, 1-hexene, and 1-octene. More preferred comonomers are ethylene and 1-butene. The most preferred comonomer is ethylene.

Generally, a heterophasic polypropylene is a propylene copolymer comprising a propylene homo or random copolymer matrix component (1) and an elastomeric copolymer component (2) of propylene with one or more of ethylene and C4-C12 olefin comonomers, wherein the elastomeric (amorphous) copolymer component (2) is dispersed in said propylene homo or random copolymer matrix polymer (1). Accordingly, the heterophasic copolymer of propylene as used herein means that the elastomeric (amorphous) propylene copolymer component (=elastomeric component) is (finely) dispersed in the polypropylene matrix component. Preferably said heterophasic propylene copolymer is present in the polymer composition in an amount from 55.0% to 97.5% by weight based on the total weight of the polymer composition, preferably from 60.0% to 97.0% by weight, preferably from 70.0% to 97.0% by weight, for example from 80.0% to 97.0% by weight, for example from 85.0% to 97.0% by weight, for example from 87.0% to 97.0% by weight based on the total weight of the polymer composition.

In some embodiment, the polypropylene for use in the polymer composition can have a melt flow index determined according to ISO 1133, condition M at 230° C. and under a load of 2.16 kg of at least 3.5 g/10 min, preferably of at least 5.0 g/10 min, preferably of at least 10 g/10 min, preferably of at least 15 g/10 min, preferably of at least 20 g/10 min.

The polymer composition also comprises a first polyethylene (A) having a melt flow rate MI2 inferior to 0.2 g/10 min.

For the purposes of the present application, the term “polyethylene” is used to denote ethylene homopolymer as well as ethylene copolymers. If the polyethylene is a copolymer, the comonomer can be any alpha-olefin i.e. any alpha-alkylene comprising from 3 to 12 carbon atoms, for example, propylene, 1-butene, and 1-hexene. The copolymer can be an alternating, periodic, random, and statistical or heterophasic copolymer.

Preferably, the first polyethylene (A) for use in the polymer composition has a high load melt index (HLMI) of at most 20.0 g/10 min, preferably of from 0.1 g/10 min to 20.0 g/10 min, preferably from 0.5 g/10 min to 10.0 g/10 min, more preferably from 0.7 g/10 min to 5.0 g/10 min, most preferably from 1.0 g/10 min to 2.5 g/10 min.

Preferably said polymer composition comprises at most 20.0% by weight of said first polyethylene (A) based on the total weight of the polymer composition, preferably at most 17.0% by weight, preferably at most 15.0% by weight, preferably at most 13.0% by weight, preferably at most 10.0% by weight, for example at most 8.0% by weight, for example at most 7.0% by weight, for example at most 6.0% by weight, for example at most 5% by weight.

In an embodiment, the polymer composition also comprises a second polyethylene (B) having a melt flow rate MI2 of at least 0.2 g/10 min. Preferably, the polyethylene (B) for use in the polymer composition has a MI2 of at most 20.0 g/10 min, preferably a MI2 of from 0.2 g/10 min to 20.0 g/10 min, preferably from 0.5 g/10 min to 15.0 g/10 min, more preferably from 1.0 g/10 min to 15.0 g/10 min, most preferably from 1.0 g/10 min to 10.0 g/10 min.

Said second polyethylene (B) is preferably present in an amount of at least 25.0% by weight, the amount being based on the combined amount of first polyethylene (A) and second polyethylene (B). Preferably, said first polyethylene (A) and said second polyethylene (B) are present in equal amounts in said polymer composition.

Preferably, the polymer composition comprises a total amount of at most 40.0% by weight of first polyethylene (A) and optional polyethylene (B) based on the total weight of the polymer composition, preferably at most 30.0% by weight, preferably at most 20.0% by weight, preferably at most 15.0% by weight.

Preferably, the polymer composition comprises a total amount of at least 2.0% by weight of said at first polyethylene (A) and second polyethylene (B) based on the total weight of the polymer composition.

The polymer composition also comprises at least one ethylene vinyl acetate copolymer (EVA) such as, e.g., polyethylene-co-vinyl acetate.

In an embodiment, said polymer composition comprises from 0.1% to 5.0% by weight of said at least one ethylene vinyl acetate copolymer based on the total weight of the polymer composition. Preferably, the polymer composition comprises from 0.1% to 5.0% by weight of said at least one ethylene vinyl acetate copolymer based on the total weight of the polymer composition, preferably from 0.5% to 5.0% by weight, preferably from 1.0% to 5.0% by weight, preferably from 1.0% to 4.0% by weight, preferably from 1.0% to 3.5% by weight.

In an embodiment, said ethylene vinyl acetate copolymer has a vinyl acetate content of at least 4.0% by weight based on the total weight of the ethylene vinyl acetate copolymer, as determined by ¹H-NMR analysis

Examples of suitable EVA polymers include products under the name EVA 1020 VN5 commercially available from TOTAL Refining and Chemicals, product under the name Elvax™, produced by DuPont, or Evatane™ produced by Arkema. Other suitable EVA polymers are commercially available from Versalis, Exxon, and Repsol.

In some embodiments, the polymer composition comprises

from 55.0% to 97.5% by weight of polypropylene based on the total weight of the polymer composition, preferably a propylene copolymer, more preferably a heterophasic propylene copolymer, preferably from 60.0% to 97.0% by weight, for example from 65.0% to 97.0% by weight; for example from 70.0% to 97.0% by weight, for example from 75.0% to 97.0% by weight; for example from 80.0% to 97.0% by weight; for example from 85.0% to 97.0% by weight; for example from 87.0% to 97.0% by weight of polypropylene, preferably a propylene copolymer, more preferably a heterophasic propylene copolymer;

at most 17.0% by weight of polyethylene (A) based on the total weight of the polymer composition, preferably at most 15.0% by weight, preferably at most 13.0% by weight, preferably at most 10.0% by weight, for example at most 8.0% by weight, for example at most 7.0% by weight, for example at most 6.0% by weight, for example at most 5% by weight; preferably at least 1.0% by weight of polyethylene (A), from 0.5% to 5.0% by weight of said at least one ethylene vinyl acetate copolymer based on the total weight of the polymer composition, preferably from 1.0% to 5.0% by weight, preferably from 1.0% to 4.0% by weight, preferably from 1.0% to 3.5% by weight; and optionally a second polyethylene (B) having a melt flow rate MI2 of at least 0.2 g/10 min.

In some embodiments, the polymer composition comprises from 75.0% to 97.0% by weight of polypropylene based on the total weight of the polymer composition, preferably a propylene copolymer, more preferably a heterophasic propylene copolymer, for example from 80.0% to 97.0% by weight, for example from 85.0% to 97.0% by weight, for example from 87.0% to 97.0% by weight of polypropylene, preferably a propylene copolymer, more preferably a heterophasic propylene copolymer;

at most 15.0% by weight of polyethylene (A) based on the total weight of the polymer composition, preferably at most 13.0% by weight, preferably at most 10.0% by weight, for example at most 8.0% by weight, for example at most 7.0% by weight, for example at most 6.0% by weight, for example at most 5% by weight; preferably at least 1.0% by weight of polyethylene (A),

from 0.5% to 5.0% by weight of said at least one ethylene vinyl acetate copolymer based on the total weight of the polymer composition, preferably from 1.0% to 5.0% by weight, preferably from 1.0% to 4.0% by weight, preferably from 1.0% to 3.5% by weight; and from 0 to 20.0% by weight of a second polyethylene (B) based on the total weight of the polymer composition, said polyethylene (B) having a melt flow rate MI2 of at least 0.2 g/10 min.

In some embodiments, the polymer composition comprises from 85.0% to 97.0% by weight of polypropylene, preferably a propylene copolymer, more preferably a heterophasic propylene copolymer based on the total weight of the polymer composition, for example from 87.0% to 97.0% by weight;

from 1.0% to 20.0% by weight of polyethylene (A) based on the total weight of the polymer composition, preferably from 1.0% to 15.0% by weight, preferably from 1.0% to 13.0% by weight, preferably from 1.0% to 10.0% by weight, for example from 1.0% to 8.0% by weight, for example from 1.0% to 7.0% by weight, for example from 1.0% to 6.0% by weight, for example from 1.0% to 5% by weight;

from 0.5% to 5.0% by weight of said at least one ethylene vinyl acetate copolymer based on the total weight of the polymer composition, preferably from 1.0% to 5.0% by weight, preferably from 1.0% to 4.0% by weight, preferably from 1.0% to 3.5% by weight; and from 1.0% to 20% by weight of a second polyethylene (B) based on the total weight of the polymer composition, said polyethylene (B) having a melt flow rate MI2 of at least 0.2 g/10 min, preferably from 1.0% to 15.0% by weight, preferably from 1.0% to 13.0% by weight, preferably from 1.0% to 10.0% by weight.

In some embodiments, the polymer composition comprises from 85.0% to 97.9% by weight of polypropylene based on the total weight of the polymer composition, preferably a propylene copolymer, more preferably a heterophasic propylene copolymer, for example from 87.0% to 97.0% by weight;

at most 13.0% by weight of polyethylene (A) based on the total weight of the polymer composition, preferably at most 10.0% by weight, for example at most 8.0% by weight, for example at most 7.0% by weight, for example at most 6.0% by weight, for example at most 5% by weight;

from 0.5% to 5.0% by weight of said at least one ethylene vinyl acetate copolymer based on the total weight of the polymer composition, preferably from 1.0% to 5.0% by weight, preferably from 1.0% to 4.0% by weight, preferably from 1.0% to 3.5% by weight; and from 1.0% to 20% by weight of a second polyethylene (B) based on the total weight of the polymer composition, said polyethylene (B) having a melt flow rate MI2 of at least 0.2 g/10 min, preferably from 1.0% to 15.0% by weight, preferably from 1.0% to 13.0% by weight, preferably from 1.0% to 10.0% by weight.

The polymer composition may comprise one or more nucleating agents. The nucleating agent used in the present invention can be any of the nucleating agents known to the skilled person. It is, however, preferred that the nucleating agent be selected from the group consisting of talc, carboxylate salts, sorbitol acetals, phosphate ester salts, substituted benzene tricarboxamides and polymeric nucleating agents, as well as blends of these.

The polymer composition may further contain additives, such as, by way of example, processing aids, mould-release agents, primary and secondary antioxidants, acid scavengers, flame retardants, fillers, nanocomposites, lubricants, antistatic additives, nucleating/clarifying agents, antibacterial agents, plastisizers, colorants/pigments/dyes and mixtures thereof. Illustrative pigments or colorants include titanium dioxide, carbon black, cobalt aluminum oxides such as cobalt blue, and chromium oxides such as chromium oxide green. Pigments such as ultramarine blue, phthalocyanine blue and iron oxide red are also suitable. These additives may be included in amounts effective to impart the desired properties.

An overview of the additives that can be used may be found in Plastics Additives Handbook, ed. H. Zweifel, 5th edition, 2001, Hanser Publishers.

The present invention also encompasses an article comprising a polymer composition according to the invention.

The present invention also encompasses a process for preparing an article, comprising the steps preparing a polymer composition according to the invention and processing said polymer composition into an article.

Preferably, the process comprises the steps of
a) blending, preferably melt blending:
   a polypropylene; preferably a propylene copolymer,
   a first polyethylene (A) having a melt flow rate MI2 inferior to 0.2 g/10 min;
   at least one ethylene vinyl acetate copolymer; and
   optionally a second polyethylene (B) having a melt flow rate MI2 of at least 0.2 g/10 min;
(b) extruding the blend,
(c) processing the extruded blend in to an article.

Preferably, said processing step comprises using one or more polymer processing techniques selected from injection molding; pipe and fiber extrusion or coextrusion; film and sheet extrusion or co-extrusion, blow molding; rotational molding; foaming; and thermoforming.

The blending of the components of the polymer composition can be carried out according to any physical blending method and combinations thereof known in the art. This can be, for instance, dry blending, wet blending or melt blending. The blending conditions depend upon the blending technique involved.

If dry blending is employed, the dry blending conditions may include temperatures from room temperature up to just under the lowest melting temperature of the polymers employed. The components can be dry blended prior to a melt blending stage, which can take place for example in an extruder. Melt processing is fast and simple and makes use of standard equipment of the thermoplastics industry. The components can be melt blended in a batch process such as in a Brabender Internal Mixer, Banbury, Haake or Clextral extruder or in a continuous process, such as in an extruder e.g. a single or twin screw extruder. During melt blending, the temperature at which the polymers are combined in the blender will generally be in the range between the highest melting point of the polymers employed and up to about 90° C. above such melting point, preferably between such melting point and up to 50° C. above it. The time required for the melt blending can vary broadly and depends on the method of blending employed. The time required is the time sufficient to thoroughly mix the components.

The polymer compositions are useful in applications known to one skilled in the art, such as forming operations (e.g., film, sheet, pipe and fiber extrusion and co-extrusion as well as blow molding, injection molding and rotational molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, pipes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example, Molded articles include single and multi-layered constructions in the form of bottles, tanks, large hollow articles, rigid food containers, crates and toys, for example.

The present invention can allow:
Reducing gels in blown film and cast film made of polypropylene copolymer compositions
Reducing gels in Extrusion Thermoforming
Improving melt strength in Blow Molding of polyethylene or polypropylene or polyethylene/polypropylene blends
Reducing gels of Automotive polypropylene compounds
Reducing gels in injection molding
Allowing extreme low volatile of metallocene polypropylene blends
Compatibilizing of recycled polypropylene stream contaminated with polyethylene

The invention will now be illustrated by the following, non-limiting illustrations of particular embodiments of the invention.

### EXAMPLES

Density

The density was measured according to the method of standard ASTM 1505 at a temperature of 23° C.

The Melt Index

The melt flow rate MI2 of polyethylene was measured according to ISO 1133:1997, condition D, at 190° C. and under a load of 2.16 kg.

The melt flow rate HLMI of polyethylene was measured according to ISO 1133:1997, condition G, at 190° C. and under a load of 21.6 kg.

The melt flow rate of polypropylene was measured according to ISO 1133:1997, condition M, at 230° C. and under a load of 2.16 kg.

The melt flow rate of the composition (blend) was measured according to ISO 1133:1997, condition M, at 230° C. and under a load of 2.16 kg

VA Content in EVA

The ¹H-NMR analysis was performed using a 500 MHz Bruker NMR spectrometer with a high temperature 5 mm probe under conditions such that the signal intensity in the spectrum is directly proportional to the total number of contributing hydrogen atoms in the sample. Such conditions are well known to the skilled person and include for example sufficient relaxation time etc. In practice, the intensity of a signal is obtained from its integral, i.e. the corresponding area. The data were acquired using 32 scans per spectrum, a pulse repetition delay of 10 seconds and a spectral width of 15 ppm at a temperature of 130° C. The sample was prepared by dissolving a sufficient amount of polymer in 1,2,4-trichlorobenzene (TCB, 99%, spectroscopic grade) at 130° C. and occasional agitation to homogenize the sample, followed by the addition of hexadeuterobenzene (C₆D₆, spectroscopic grade) and a minor amount of hexamethyldisiloxane (HMDS, 99.5+%), with HMDS serving as internal standard. To give an example, about 60 mg of polymer were dissolved in 0.5 ml of TCB, followed by addition of 0.25 ml of C₆D₆ and 1 drop of HMDS. Following data acquisition, the chemical shifts are referenced to the signal of the internal standard HMDS, which is assigned a value of δ0.055 ppm. The VA content was determined by ¹H-NMR analysis on the total polymer. The different chemical shifts can be found below in Table 1 and were assigned using published data.

TABLE 1

| Sort of Hydrogen | Chemical shifts (ppm) |
|---|---|
| 1H mono | 7.2 |
| CHO VA + 1H mono | 5.2-4.56 |
| 1H mono | 4.5 |
| CH₃ VA | 2.1-1.9 |
| 4E + 5VA + 3H mono | 2.6-0.5 |

The following normalized areas are defined to estimate the VA content:

Mono area=(H mono 7.2 ppm+H mono 4.5 ppm)/2

VA area=(CHO VA+1H mono area)—mono area

E area=((4E+5VA+3H mono) area—5 VA area—3 mono area)/4

The VA content is then calculated according to the following equation:

VA content (% weight)=VA area*8600/(mono area*86+VA area*86+E area*28)

Flexural Modulus

The flexural modulus was determined according to ISO 178:2011 method A with the conditions listed in Table 2.

TABLE 2

| Temperature | 23° C. |
|---|---|
| Test machine | 00-0311 (Zwick tensile testing machine) |
| Force sensor | 200N cell |
| Displacement transducer | Extensometer |
| Norm | ISO-178: 2011 method A |
| Test specimen | bar 80 mm × 10 mm × 4 mm cut from |
| | type 1A specimen |
| Pre-charge | 0.5N |
| Test speed | 2 mm/min |
| Span between specimen | 64 mm |
| supports | |
| End of the test | 1.5% |
| Relative humidity | 50% ± 10% |

Tensile Modulus Properties

Tensile properties were measured according to ISO 527-1A with the conditions listed in Table 3.

TABLE 3

| Temperature | 23° C. |
|---|---|
| Test machine | 00-0311 (Zwick tensile testing machine) |
| Force sensor | 10 kN |
| Displacement transducer | Extensometer |
| Norm | ISO-527: 2012 |
| Test specimen | type 1A |
| Pre-charge | 5N |
| Modulus speed | 1 mm/min |
| Test speed | 50 mm/min |
| Thickness average | 4.07 mm |
| Average width | 10.05 mm |
| Relative humidity | 50% ± 10% |

Falling Weight Impact test

The falling weight test on 60×60×2 mm plaques was performed according to ISO 6603-2:2002 with the following conditions: The tests were done on a Fractovis Ceast equipment with a hammer M2091 having a diameter of 12.7 mm and a weight of 19.927 kg. The hammer was not lubricated. The test speed was 4.43 m/s. the number of points was 15000. The frequency was 1333 kHz. An internal digital trigger was used. Test specimens were in the form injection-molded plates and had the following dimensions 60×60×2 mm. The diameter of the sample holder was 40 mm. The tests were carried out at a temperature of −30° C., −20° C., −10° C., 0° C., 4° C., 10° C., 15° C., 23° C., and 30° C. The height was 1.0 m and the impact energy was 195.44 J. The results are based upon an average of 5 samples.

Ductility index (DI) (%)=((Energy at break−Energy at Peak)/Energy at break)×100

Default classification: (≤10: Fragile, >10 and ≤35: intermediate, >35: Ductile)

Gels Content

Polymer pellets were extruded into a film. The gels were counted using an Optical control systems (OCS®) (www.ocsgmbh.com), which comprised an extruder of the type ME connected to a cast film unit which is connected to a Film Surface Analyzer FSA100 from Optical Control Systems. Film thickness was 70 μm.

Notched Izod

Notched Izod was performed according to ISO 180:2001, V notch sample type 1A, with the conditions listed in Table 4. Izod impact is defined as the kinetic energy needed to initiate a fracture in a polymer sample specimen and continue the fracture until the specimen is broken. Tests of the Izod impact strength determine the resistance of a polymer sample to breakage by flexural shock as indicated by the energy expended from a pendulum type hammer in breaking a standard specimen in a single blow. The specimen is notched which serves to concentrate the stress and promote a brittle rather than ductile fracture. Specifically, the Izod impact test measures the amount of energy lost by the pendulum during the breakage of the test specimen. The energy lost by the pendulum is the sum of the energies required to initiate sample fracture, to propagate the fracture across the specimen, and any other energy loss associated with the measurement system (e.g., friction in the pendulum bearing, pendulum arm vibration, sample toss energy, etc.).

TABLE 4

| | |
|---|---|
| Temperature | 23° C. |
| Norm | ISO 180: 2001 |
| Impact energy | 1.00 J |
| Notch type | V-Notch Type 1A |
| Test specimen | bar 80 mm × 10 mm × 4 mm cut |
| | from type 1A specimen |

Injection Molding Conditions. The test specimens for Flexural Modulus, Izod, Falling Weight et and Tensile properties determination were prepared by injection molding.

Test specimens type 1A (Flexion, Izod, Traction): norm ISO 294-1:1998
Cycle time=60 s
Injection: pressure=1200 bar, time=1.9 s
Holding: pressure=280 bar, time=40 s
Temperature profile=180° C. to 200° C.
Mold temperature=30° C.
Cooling time=14.5 s

Test specimens type D2 (Falling weight): norm ISO 294-3:1998 plaques
Cycle time=60 s
Injection: pressure=1200 bar, time=0.6 s
Holding: pressure=575 bar, time=40 s
Temperature profile=180 to 200° C.
Mold temperature=30° C.
Cooling time=15.5 s

RDA (Melt Viscosity)

Dynamic rheometry analyses (RDA) were performed on an ARES rheometer from TA Instruments (Waters SA), measured on parallel plates with a diameter of 25 mm. Temperature was 230° C., and the scanning frequency was from 0.1 to 320 rad/s. It is a measure of the resistance to flow of material placed between two parallel plates rotating with respect to each other with an oscillatory motion. The apparatus comprises a motor that transmits a sinusoidal deformation to the sample. The sample then transmits the resulting constraint, said resulting constraint being also sinusoidal. The material to be studied can be a solid attached between two anchoring points or it can be melted between the two plates. The dynamic rheometer allows the simultaneous measurement of both the elastic modulus and the viscous modulus of the material. Indeed, the resulting sinusoidal constraint is displaced by a phase angle δ with respect to the imposed deformation and it is mathematically possible to decompose the resulting sinusoid into:
a first sinusoid in phase with the initial deformation that represents the elastic component of the material. Said component conserves energy.
a second sinusoid displaced by a phase angle of π/2 with respect to the initial deformation that represents the viscous component. Said component dissipates energy into heat.

The initial deformation is represented by the formula γ=γ₀ sin (ωt) wherein ω is the frequency. The resulting constraint is thus of the form τ=τ₀ sin (ωt+δ). The complex modulus is given by the formula G=τ/γ. The complex modulus can be decomposed into the elastic modulus G′ and the viscous modulus G″ defined respectively as G′=G cos (δ) and G″=G sin(δ). The complex viscosity is defined as G/w. At constant temperature and constant deformation amplitude, G″ and G″ can be measured for different values of w. The measurements were carried out under the following operating conditions: a constant operating temperature of 230° C., —parallel plates separated by 1.5 mm, —maximum deformation maintained at 10%. The elastic component G′ and the viscous component G″ can be graphed as a function of frequency ω. The point of intersection between the elastic and viscous curves, called the cross-over point (COP), is characterized by a frequency ω_{c} and a viscosity component G_{c}. The cross-over point is characteristic of each polymer and is a function of the molecular weight and of the molecular distribution.

Melt temperature by DSC

The melt temperature was measured by DSC (Differential Scanning calorimetry) according to ISO 11357-3:2013. The test conditions were the following:
Equilibrate the sample at 40° C.
Ramp 20° C./min to 220° C.
Isothermal for 3 minutes
Ramp 20° C./min to 30° C.
Isothermal for 2.00 min
Ramp 20.00° C./min to 220.00° C.→The Melt temperature was determined at this stage of the test method at the peak of heat flow.

### Example 1

In this example, the following components were used:

Polypropylene PPC 10642 is a commercial nucleated antistatic heterophasic copolymer with a melt flow rate of 44 g/10 min as determined according to ISO 1133 (230° C., 2.16 kg) commercially available from TOTAL Refining and Chemicals.

EVA 1020 VN 5 is a commercial ethylene vinyl acetate copolymer with a melt flow rate of 2 g/10 min as determined according to ISO 1133 (190° C., 2.16 kg), with a VA content of 17.5%, a melting temperature of 87° C. (ISO 11357-3:2013) and a density of 0.940 g/cm³ (ISO 1183-2:2005) commercially available from TOTAL Refining and Chemicals.

HDPE 56020 XP is a commercial very high molecular weight high density polyethylene sold as a pellet grade and containing antioxidants having a melt flow rate HLMI of 1.4 g/10 min as determined according to ISO 1133 (190° C., 21.6 kg), a MI2 of 0.02 g/10 min as determined according to ISO 1133 (190° C., 2.16 kg) and a density of 0.952 g/cm³ (ISO 1183-2:2005), commercially available from TOTAL Refining and Chemicals.

Lumicene® mPE M4040 is a commercial metallocene based polyethylene having a melt flow rate MI2 of 4.0 g/10 min as determined according to ISO 1133 (190° C., 2.16 kg), and a density of 0.940 g/cm³ (ISO 1183-2:2005), commercially available from TOTAL Refining and Chemicals.

Different compositions were produced. The components of the compositions are shown in Table 5. Unless otherwise stated the amounts are given in weight % (wt. %), based on the total weight of the composition.

TABLE 5

| | | HDPE | Lumicene | |
|---|---|---|---|---|
| | PPC | 56020 | mPE | EVA |
| | 10642 | XP | M4040 | 1020VN5 |
| PPC 10642 | 100 | | | |
| Comparative composition 3 | 90 | 2.5 | 7.5 | |
| Comparative composition 4 | 90 | 5 | 5 | |
| composition 1 according | 89 | 2.5 | 7.5 | 1 |
| to the invention | | | | |
| composition 2 according | 89 | 5 | 5 | 1 |
| to the invention | | | | |

Compositions 1 and 2 according to the invention and comparative compositions 3 and 4 were extruded on Brabender 20/40 extruder, using the following conditions:
Twin screw co-rotating, 20 mm screw diameter, L/D=40
Screw speed=200 rpm
Temperature profile=180/190/190/190/190/190° C.

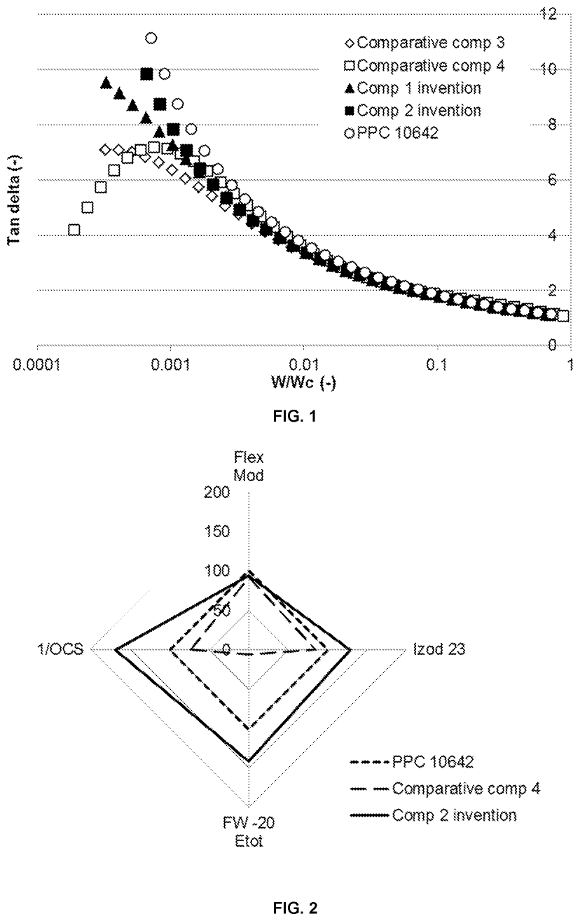

The properties of the samples prepared with the compositions were measured. The results are shown in Table 6 and FIGS. 1 and 2.

TABLE 6

| | | | Com- | Com- | com- | com- |
|---|---|---|---|---|---|---|
| | | | parative | parative | position 1 | position 2 |
| | | | com- | com- | according | according |
| | | PCC | position | position | to the | to the |
| | | 10642 | 3 | 4 | invention | invention |
| MFI 230° C./ | g/10 | 46.5 | 36.7 | 35.2 | 37.9 | 39.9 |
| 2.16 kg | min | | | | | |
| RDA C1 | | 390 | 563 | 573 | 522 | 498 |
| RDA Wc | s-1 | 650 | 666 | 534 | 659 | 700 |
| Tensile | MPa | 1368 | 1246 | 1263 | 1251 | 1301 |
| Modulus | | | | | | |
| Yield stress | MPa | 25.4 | 22.7 | 22.4 | 23.5 | 24 |
| Elongation | % | 33.7 | 6.3 | 5.5 | 17.8 | 19.6 |
| at break | | | | | | |
| Flexural | MPa | 1414 | 1272 | 1294 | 1271 | 1323 |
| Modulus | | | | | | |
| Modulus 1% | % | 1294 | 1156 | 1174 | 1155 | 1205 |
| Izod 23° C. | kJ/m² | 7.3 | 6.8 | 6.2 | 9.4 | 9.4 |
| Izod −20° C. | kJ/m² | 3.9 | 3.4 | 3.1 | 4.7 | 4.9 |
| FW −20° C. | J | 12 | 0.95 | 0.66 | 16.5 | 17 |
| Energy tot | | | | | | |
| OCS | gels/m² | 7649 | 232440 | 208579 | 261 | 201 |

In comparative compositions 3 and 4, the presence of a small fraction, as low as 2.5%, of HMW PE (highly viscous PE such as HDPE 56020 XP with a HLMI of 1.4 g/10 min) was enough to destroy the compatibility and the homogeneity of the PP/PE blend. Compositions 1 and 2 according to the invention comprised EVA which surprisingly allowed improving greatly the compatibility of highly viscous PE with the PP matrix.

The heterogeneity in the comparative compositions was clearly visible on:
Mechanical properties: tensile test (elongation at break), falling weight impact (energy of impact).
Rheological behavior: typical high melt flow PPC show high tan delta at low shear rate; the addition of HMW PE changed this behavior with a sudden drop of tan delta at very low shear; the presence of EVA (as in the composition according to the invention) allowed recovering the original behavior of the neat PPC (FIG. 1).
OCS films: the poor dispersion of HMW PE in the comparative compositions made the film full of uncountable gels, even holes; the presence of EVA (as in the composition according to the invention) allowed eliminating all gels thanks to a good compatibility between the phases.
Injection molded plaques: during the molding of the sample plaques, a bad surface aspect was noticed for the two comparative examples; the presence of EVA in the composition according to the invention allowed preparing plaques with as good aspect as the neat PPC.
During the extrusion of the blends on the twin screw extruder, irregular strands were also noticed for the comparative examples in contrast to the compositions according to the invention which were free of these defects.
Melting behavior by DSC: the lack of compatibility observed with the presence of HMW PE in the comparative compositions was also responsible for unprecise results of melting peaks
The FIG. 2 shows on a radar chart some of the advantages of the invention with a combination of lower gels by OCS, a higher impact resistance by Izod 23° C. and Falling Weight −20° C. while keeping a similar Flexural Modulus.

This invention can also allow improving the homogeneity (measured by a reduction of gels/m²) of a post-consumer recycled PP resin containing some PE and exhibiting more than 10000 gels/m² by adding EVA.

1.-15. (canceled)

16. A polymer composition comprising:
a polypropylene;
a first polyethylene (A) having a melt flow rate MI2 inferior to 0.2 g/10 min as determined according to ISO 1133, condition D, at 190° C. and under a load of 2.16 kg;
at least one ethylene vinyl acetate copolymer; and
optionally a second polyethylene (B) having a melt flow rate MI2 of at least 0.2 g/10 min as determined according to ISO 1133, condition D, at 190° C. and under a load of 2.16 kg;
wherein the flow rate ratio of the melt flow rate of the polypropylene, determined according to ISO 1133, condition M at 230° C. and under a load of 2.16 kg, to the melt flow rate MI2 of the first polyethylene (A) is at least 200.

17. The polymer composition according to claim 16, wherein the polypropylene is a propylene copolymer.

18. The polymer composition according to claim 16, wherein the polypropylene is a heterophasic propylene copolymer.

19. The polymer composition according to claim 16, wherein the polymer composition comprises at most 20.0% by weight of the first polyethylene (A) based on the total weight of the polymer composition.

20. The polymer composition according to claim 16, wherein the polymer composition comprises from 55.0% to 97.5% by weight of the at least one polypropylene based on the total weight of the polymer composition.

21. The polymer composition according to claim 16, wherein the polymer composition comprises from 0.5% to 5.0% by weight of the at least one ethylene vinyl acetate copolymer based on the total weight of the polymer composition.

22. The polymer composition according to claim 16, wherein the polymer composition comprises a total amount of at most 40.0% by weight of first polyethylene (A) and optional polyethylene (B) based on the total weight of the polymer composition.

23. The polymer composition according to claim 16, wherein the polymer composition comprises at least 1.0% by weight of the second polyethylene (B) having a melt flow rate MI2 of at least 0.2 g/10 min.

24. The polymer composition according to claim 16, wherein the second polyethylene (B) has a melt flow rate MI2 of at most 20.0 g/10 min.

25. The polymer composition according to claim 16, wherein the polymer composition comprises a total amount of at least 2.0% by weight of the at first polyethylene (A) and second polyethylene (B) based on the total weight of the polymer composition.

26. The polymer composition according to claim 16, wherein the second polyethylene (B) is present in an amount of at least 25.0% by weight, the amount being based on the combined amount of first polyethylene (A) and second polyethylene (B).

27. The polymer composition according to claim 16, wherein the first polyethylene (A) and the second polyethylene (B) are present in equal amounts in the polymer composition.

28. An article comprising a polymer composition according to claim 16.

29. The article according to claim 28, wherein the article is an injected or extruded article.

30. A process for making an article according to according to claim 28 comprising the steps of preparing a polymer composition comprising:
a polypropylene;
a first polyethylene (A) having a melt flow rate MI2 inferior to 0.2 g/10 min as determined according to ISO 1133, condition D, at 190° C. and under a load of 2.16 kg;
at least one ethylene vinyl acetate copolymer; and
optionally a second polyethylene (B) having a melt flow rate MI2 of at least 0.2 g/10 min as determined according to ISO 1133, condition D, at 190° C. and under a load of 2.16 kg;
wherein the flow rate ratio of the melt flow rate of the polypropylene, determined according to ISO 1133, condition M at 230° C. and under a load of 2.16 kg, to the melt flow rate MI2 of the first polyethylene (A) is at least 200;
and processing the polymer composition into an article.
